(19) United States
(12) Patent Application Publication
(10) Pub. No.: US 2011/0246066 A1
(43) Pub. Date: Oct. 6, 2011

(54) Method and System for Managing Media Items

(75) Inventors: Jong Goo LEE, Herzliya (IL); Andrey Severyn, Tel Aviv (IL); Gilad Haimov, Tel Aviv (IL)

(73) Assignee: Epsillion Media Technologies Ltd., Tel Aviv (IL)

(21) Appl. No.: 12/752,131

(22) Filed: Apr. 1, 2010

(51) Int. Cl. G01C 21/00; G06F 3/16; G06F 3/14; G06F 17/00

(52) U.S. Cl. 701/209; 701/200; 715/727; 707/609; 707/E17.018; 707/E17.058

(57) ABSTRACT

The subject matter discloses a computerized system comprising an input module configured to obtain a media item and a Geographic Location Data Record (GLDR), the media item is associated with the GLDR, a media item repository configured to store the media item, a meta-data determinator configured to determine a meta-data associated with the media item, said meta-data is based on the GLDR; and a display module for displaying the media item stored in said media item repository, the media item is displayed in accordance with the GLDR and the meta-data determined by said meta-data determinator.

### FIELD OF THE INVENTION

The subject matter generally relates to managing media items, more specifically to the field of associating media items with location based data.

### BACKGROUND

It is common that a media item, such as a image, may be displayed on a map according to a Geographic Location Data Record (GLDR) or another data related to location. The GLDR may represent a location of an item, such as a building or a statue, which is shown in the image. The GLDR may also represent the location in which the media item was created.

The image may be taken using a Smartphone for example. The Smartphone may comprise a Global Positioning System (GPS) that may determine a GLDR where the image was taken.

The media item displayed on the map may be used by travelers looking for or visiting a site, a person in an urban environment searching a building, a person searching where he parked his car or the like.

### BRIEF DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a computerized environment in which the disclosed subject matter is used, in accordance with some exemplary embodiments of the subject matter;

FIG. 2 shows a block diagram of a media item manager, in accordance with some exemplary embodiments of the disclosed subject matter;

FIG. 3 shows a flow of a method, in accordance with some exemplary embodiments of the disclosed subject matter; and

FIG. 4 shows a block diagram of a display configuration, in accordance with some exemplary embodiments of the disclosed subject matter.

### SUMMARY OF THE INVENTION

It is an object of the subject matter to disclose a computerized system comprising an input module configured to obtain a media item and a Geographic Location Data Record (GLDR), the media item is associated with the GLDR; a media item repository configured to store the media item; a meta-data determinator configured to determine a meta-data associated with the media item, said meta-data is based on the GLDR; and a display module for displaying the media item stored in said media item repository, the media item is displayed in accordance with the GLDR and the meta-data determined by said meta-data determinator.

In some embodiments, the media item is selected from the group consisting of an image item, a video item and an audio item. In some embodiments, said meta-data determinator comprises a media item labeler configured to label the media item based on the GLDR.

In some embodiments, said input module is further configured to obtain a temporal indication associated with the media item, said media item labeler is configured to label the media item based on the GLDR and the temporal indication.

In some embodiments, said meta-data determinator comprises a collection associator configured to associate a collection of two or more media items with the media item based on the GLDR associated with the media item. In some embodiments, said input module is further configured to obtain a temporal indication associated with the media item, said collection associator is configured to associate the collection with the media item based on the GLDR and the temporal indication.

In some embodiments, said meta-data determinator further comprises a collection labeler configured to label the collection based on GLDRs associated with the two or more media items of the collection.

In some embodiments, said input module is further configured to obtain a temporal indication associated with the media item, said collection labeler is configured to label the collection based on the GLDRs and temporal indications associated with the two or more media items of the collection.

In some embodiments, said meta-data determinator further comprises a route determinator configured to determine a route based on GLDRs associated with the two or more media items of the collection.

In some embodiments, said input module is further configured to obtain a temporal indication associated with the media item, said route determinator is configured to determine a route based on the GLDRs and temporal indications associated with the two or more media items of the collection.

In some embodiments, the computerized system further comprises a map display module configured to display a map in accordance with the meta-data of the media item.

In some embodiments, the display module further comprises a collection display module configured to display at least a portion of the two or more media items of the collection.

In some embodiments, said map display module is configured to modify the map based on a selection of a media item from an at least a portion of two or more media items. In some embodiments, the input module is further configured to obtain a current location of said computerized system. In some embodiments, the display module is further configured to display the media item in accordance with the current location of said computerized system.

It is another object of the subject matter to disclose a method in a computerized environment, said method comprising obtaining a media item and a GLDR, the media item is associated with the GLDR, storing the media item, determining a meta-data associated with the media item based on the GLDR and displaying the media item stored, the media item is displayed in accordance with the GLDR and the meta-data.

In some embodiments, the method further comprises a step of labeling the media item based on the GLDR.

In some embodiments, the method further comprises a step of obtaining a temporal indication associated with the media item; and labeling the media item based on the GLDR and the temporal indication.

In some embodiments, the method further comprises a step of associating a collection of two or more media items with the media item based on the GLDR.

In some embodiments, the method further comprises steps of obtaining a temporal indication associated with the media item; and associating the collection with the media item based on the GLDR and the temporal indication.

In some embodiments, the method further comprises a step of labeling the collection based on GLDRs associated with the two or more media items of the collection.

In some embodiments, the method further comprises steps of obtaining a temporal indication associated with the media item; and labeling the collection based on the GLDRs and temporal indications associated with the more than one media item associated with the collection.

In some embodiments, the method according determines a route based on GLDRs associated with the two or more media items of the collection.

In some embodiments, the method obtains a temporal indication associated with the media item; and determines a route based on the GLDRs and temporal indications associated with the two or more media items of the collection.

### DETAILED DESCRIPTION

One technical problem dealt with by the disclosed subject matter is to determine a meta-data for a media item.

One technical solution is to utilize a GLDR associated with the media item in order to determine the meta-data for the media item. Yet another technical solution is to utilize the GLDR and a temporal indication associated with the media item in order to determine the meta-data for the media item.

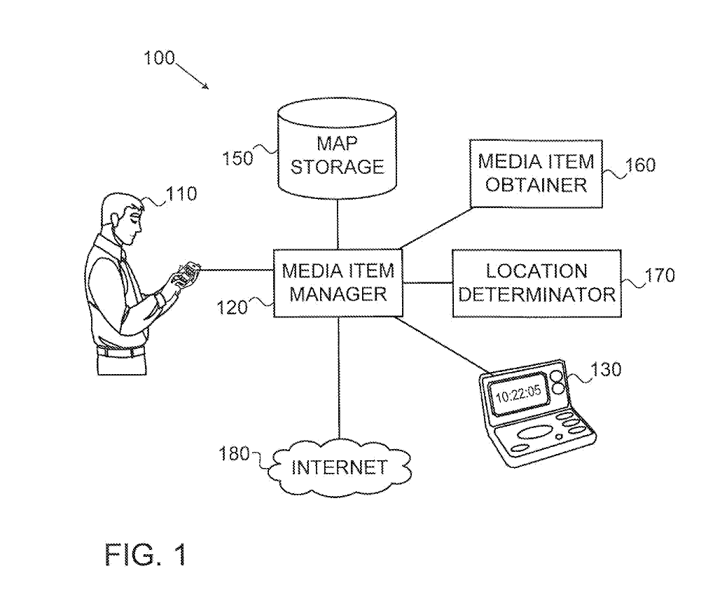

FIG. 1 shows a computerized environment in which the disclosed subject matter is used, in accordance with some exemplary embodiments of the disclosed subject matter. A computerized environment 100 may comprise a media item obtainer 160. The media item obtainer 160 may be configured to obtain a media item, such as a image item, a video item and an audio item. The media item obtainer 160 may be a camera, a video camera, a tape recorder, a cellular phone comprising a camera or the like. The media item obtainer 160 may be any device or module capable of generating or receiving a media item from another computerized or electronic entity, such as a camera.

The media item is associated with a GLDR. The GLDR may comprise a geographic location or a coordinate associated with a location, a geosynchronous location, a location obtained from a GPS receiver, a distance from a known geographic coordinate or the like. The GLDR may be obtained by a location determinator 170. The location determinator 170 may be a GPS receiver, a cellular phone comprising a GPS receiver, a device or system using a triangulation process, or any other device that may determine a location or coordinate associated with a location. In one exemplary embodiment the GLDR may represent a location where the media item was generated, for example, the location where an image was taken. In other cases, the GLDR may represent a location in which a media item was received from another computerized device, a location or a set of locations which are associated to the media item by a user or the like.

The media item and the GLDR associated with the media item are transferred to a media item manager 120. The media item manager 120 may be configured to provide a user 110 with a display of output records based on the media item and the GLDR. Such output records may be, for example, labeling the media item, collecting media items into a collection, labeling the collection, determining a route based on the collection and the like. The user 110 may be a traveler on a road trip, a person in an urban environment, a person searching where he parked his car or the like. In some exemplary cases, processing the data that results in the output records disclosed above is performed by the media item manager 120.

In some exemplary embodiments of the disclosed subject matter, the computerized environment 100 may comprise a clock 130. The clock 130 may be comprised by or communicating with a video camera, a camera, a cellular phone and the like. The clock 130 may generate a temporal indication associated with the media item. The clock 130 may also transfer the temporal indication to the media item manager 120. The temporal indication may represent a time in which the media item was generated, for example, the time of filming a video. The temporal indication may alternatively represent the time in which the media item was received at a computerized device. The media item manager 120 may be configured to provide the user 110 with a display of the output records based on the media item, the GLDR and the temporal indication associated with the media item.

The computerized environment 100 may further comprise a map storage 150. The map storage 150 may store maps with a multiple number of layers. Each layer may comprise a different resolution for reviewing a GLDR in a map. The media item manager 120 may utilize a portion of the maps stored in the map storage 150 when providing the output records.

The media item manager 120 may further utilize a communication network such as the Internet 180 or any intranet for downloading or uploading data associated with the disclosed subject matter. In one exemplary embodiment, the media item manager 120 may download media items and GLDRs. In another exemplary embodiment, the media item manager 120 may provide the display of the output records to a remote user through the Internet 180.

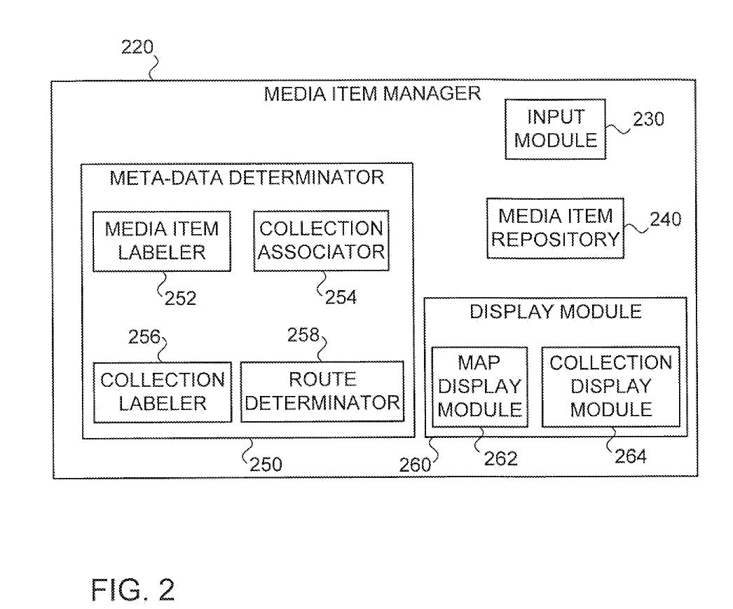

FIG. 2 shows a block diagram of a media item manager in accordance with some exemplary embodiments of the disclosed subject matter. A media item manager 220 is equivalent to the media item manager 120 of FIG. 1, and may comprise an input module 230, a media item repository 240, a meta-data determinator 250 and a display module 260.

The input module 230 may be configured to obtain a media item and a GLDR associated with the media item. The input module 230 may obtain the media item from a media item obtainer, such as 160 of FIG. 1. The input module 230 may obtain the GLDR associated with the media item from a location determinator, such as 170 of FIG. 1. In some embodiments, the input module 230 may obtain a current location of the media item manager 220 from the location determinator. In some exemplary embodiments, the input module 230 may be further configured to obtain a temporal indication associated with the media item. The input module 230 may obtain the temporal indication from a clock, such as 130 of FIG. 1. The input module 230 may transfer the media item, the GLDR and the temporal indication to the media item repository 240.

The media item repository 240 is configured to store media items along with associated GLDRs and other meta-data. In some exemplary embodiments, the media items, the GLDR and the other meta-data may be stored along with temporal indications associated with the media items.

The meta-data determinator 250 may be configured to determine a meta-data associated with a media item. Such meta-data may be used in providing the output records to the user. The meta-data may be a label of a media item, an association of a media item with a collection of media items, a label of a collection comprising the media item, a route determined according to the collection of media items and the like. The meta-data determinator 250 may determine a meta-data associated with a media item stored in the media item repository 240. The meta-data determinator 250 may comprise a media item labeler 252. The media item labeler 252 may be configured to automatically label the media item. Labeling the media item may be based on GLDR associated with the media item. For example, a label of the media item may be a name of a country name, a city name, a street name or the like. In some embodiments, a user may determine the label manually.

In some exemplary embodiments, the media item labeler 252 may automatically label the media item based on the GLDR and associated temporal indication. For example, a label of the media item may be a country name and a year, a city name and a month, a street name and an hour or the like. In some exemplary embodiments, the label of the media item may comprise a textual description which is associated with the GLDR by other users. For example, the media item labeler 252 may label the media item according to labels of other media items associated with a geographically close GLDR. Such labels may be obtained through the interne, for example obtained from a social network.

The meta-data determinator 250 may further comprise a collection associator 254. The collection associator 254 may be configured to associate a collection of two or more media items with another, media items based on GLDRs associated with the media items. The collection associator 254 may further utilize statistical tools on a plurality of GLDRs associated with the media items in order to associate the media items with a collection. For example, several media items associated with several GLDRs located within a certain radius are associated with a collection.

In some exemplary embodiments, the collection associator 254 may be configured to associate a collection with one or more media items based on a plurality of GLDRs and temporal indications associated with the one or more media items. For example, media items associated with a plurality of GLDRs located within a certain radius and further associated with temporal indications of a certain time period are associated with a certain collection.

The meta-data determinator 250 may further comprise a collection labeler 256. The collection labeler 256 may be configured to automatically label the collection based on the plurality of GLDRs associated with the media items of the collection. For example, a label of the collection may be a name of a country, a city, a street or the like, which corresponds to the GLDRs associated with the media items associated with the collection. In some exemplary embodiments, the label of the collection may be modified in case a media item is added to the collection or removed from the collection.

In some exemplary embodiments, the collection labeler 256 may be configured to automatically label a collection based on the plurality of GLDRs and the temporal indications associated with the media items of the collection. For example, a label of the collection may be a location name and a year, a city name and a month, a street name and an hour or the like, which corresponds to the plurality of GLDRs and temporal indications associated with the media items of the collection. In some alternative embodiments, the label of a collection may be based on labels of media items associated with the collection.

The meta-data determinator 250 may further comprise a route determinator 258. The route determinator 258 may be configured to determine a route based on the plurality of GLDRs associated with the media items of the collection. For example, the route may be a path comprising two or more GLDRs associated with the media items of the collection. The route may use external data, such as streets and roads, and determine the shortest path between the GLDRs based on said external data. The route may also comprise direct lines drawn between the GLDRs. The route may be displayed on a display module of the media item manager 220.

In some exemplary embodiments, the route determinator 258 may further be configured to determine a route based on a plurality of GLDRs and temporal indications associated with media items of the collection. For example, the route may be a path comprising the plurality of GLDRs based on the temporal indications associated with same media items. A first GLDR of the path may be associated with an early temporal indication and a second GLDR of the path may be associated with a later temporal indication. In such case, the route may be determined in a chronological order according to the temporal indications from earliest to latest. In some embodiments, the route may be the route which a user is taking at the time the media items are generated. In some other cases, the route may contain geosynchronous data which relates to the actual route which was taken by the media creator at the time he the media items were actually created.

The display module 260 may be configured to utilize the meta-data determinator 250 in order to display a one or more output records, such as collections, routes and the like. In some exemplary cases, the display module 260 may comprise two or more display sections. One such display section may be a map display module 262. The map display module 262 may be configured to display a map and a media item stored in the media item repository 240 on the map. The media item is displayed in accordance with an associated GLDR and meta-data determined by the meta-data determinator 250. in some embodiments, the map display module 262 may further be configured to display the media item in accordance with the current location of the media item manager 220 obtained by the input module 230. The map display module 262 may utilize a map comprised by a map storage, such as the map storage 150 of FIG. 1.

The display module 260 may comprise a collection display module 264. The collection display module 264 may be configured to display media items associated with a collection according to the collection associator 254. The collection display module 264 may further display a route determined by the route determinator 258 according to the collection.

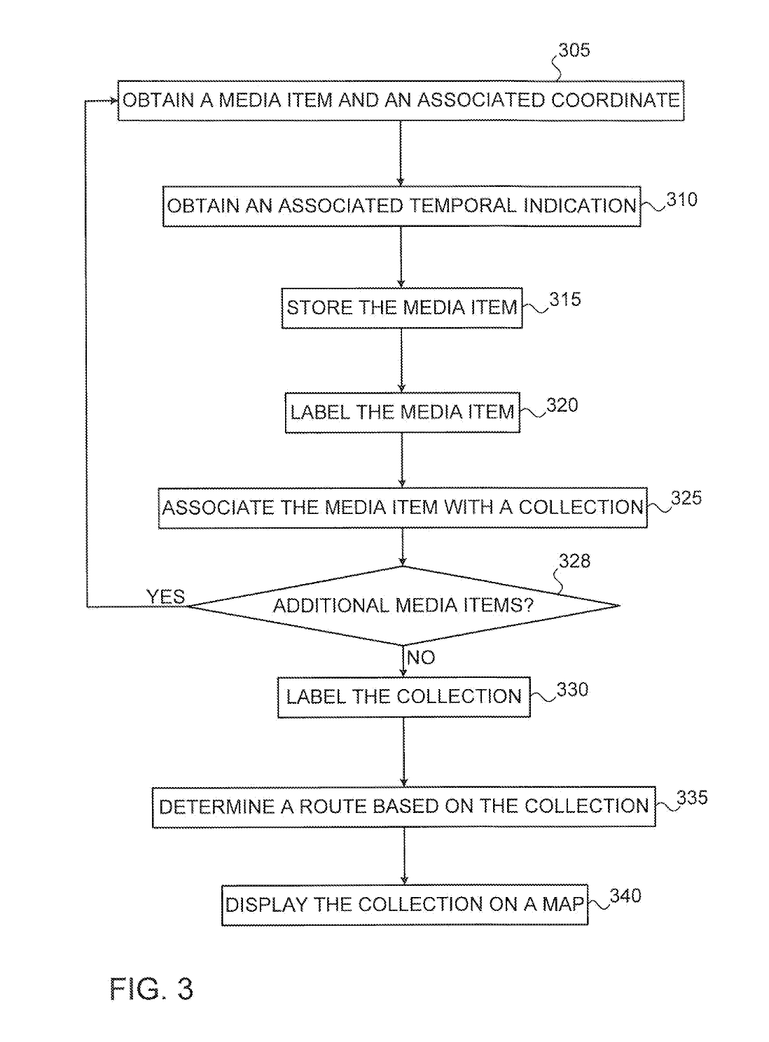

FIG. 3 shows a flow of a method, in accordance with some exemplary embodiments of the disclosed subject matter.

In step 305, a media item and an associated GLDR are obtained. The media item and the GLDR may be obtained by an input module, such as 230 of FIG. 2. The input module may obtain the media item from a media item obtainer, such as 160 of FIG. 1. The input module may obtain the GLDR from a location determinator, such as 170 of FIG. 1.

In step 310, a temporal indication associated with the media item is obtained. The temporal indication may be obtained by an input module, such as 230 of FIG. 2. The input module may obtain the temporal indication from a clock, such as 130 of FIG. 1. Step 310 is optional and may not be performed in some exemplary embodiments.

In step 315, the media item is stored. The media item may be stored in a media item repository, such as 240 of FIG. 2. In some exemplary embodiments, the media item is stored with an associated GLDR and other meta-data. In some exemplary embodiments, the media items, the GLDR and the other meta-data may be stored with temporal indication associated with the media item.

In step 320, the media item is labeled. The media item may be labeled by a media item labeler, such as 252 of FIG. 2. Labeling may be performed automatically, without any command from a user. Labeling may be performed according to a location or timestamp associated with the labeled media item.

In step 325, the media item is associated with a collection. The collection may be comprised of two or more media items. The media item may be associated with the collection by a collection associator, such as 254 of FIG. 2. The media item is associated with another media items of the collection based on a plurality of GLDRs associated with the media items of the collection.

In step 328, a decision is made. If there are additional media items to be handled, the next step is 305 in a loop configuration, until no other media items are left. If there are no additional media items then the next step is 330. In step 330, the collection is labeled. The collection may be labeled by a collection labeler, such as 256 of FIG. 2. In some exemplary embodiments, step 330 may be performed only after a number of media items have been associated with the collection. Labeling the collection may be performed automatically after a predefined number of media items are associated with the collection.

In step 335, a route is determined based on the collection. The route may be determined by a route determinator, such as 258 of FIG. 2. The route may be modified if a new media item is associated with the collection. The route may be determine if a command from a user is received to, requiring the media item manager to determine a route based on a certain collection. The route may be determined based on a set of rules. For example, the route may be a shortest path comprising the plurality of GLDRs associated with media items that comprising the collection. In some exemplary embodiments, several routes may be collected together forming a collection of routes. Such routes may be associated by a user with a certain trip. The collection of routes may be shared with other users through the internet. For example, the user may post the collection of routes in his personal homepage, in a personal blog, in social networks or the like.

In step 340, the collection is displayed on a map. The collection may be displayed by a collection display module, such as 264 of FIG. 2. In some exemplary embodiments the route determined based on the collection is further displayed in the step 340. In some exemplary embodiments a single media item is displayed in the step 340. The single media item may be displayed by a map display module, such as 262 of FIG. 2.

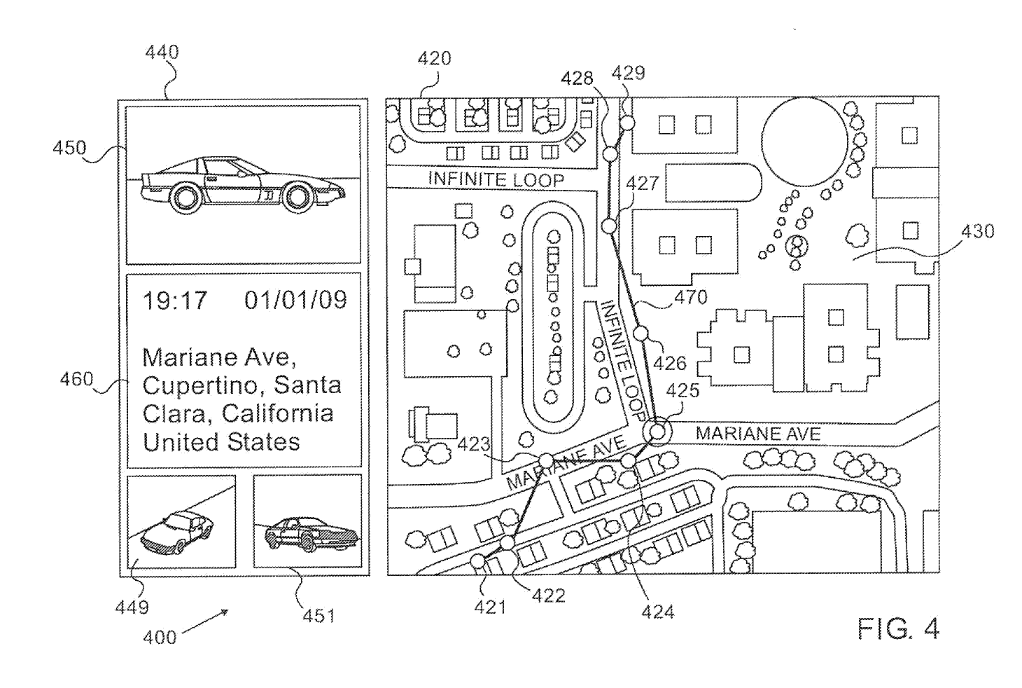

FIG. 4 shows a block diagram of a display configuration, in accordance with some exemplary embodiments of the disclosed subject matter. A display configuration 400 may describe a display provided by a display module, such as 260 of FIG. 2.

The display configuration 400 may comprise a first display section 420 and a second display section 440. The first display section 420 may comprise a map 430. The map 430 may be a map stored in a map storage, such as 150 of FIG. 1.

The first display section 420 may further displays plurality of GLDRs associated with media items. The plurality of GLDRs associated with the media items are represented by points 421, 422, 423, 424, 425, 426, 427, 428 and 429 on the map 430. The point 425 is circled in order to represent a selected GLDR. The media items may be associated with a certain collection. The collection may be associated with a media item that is not shown on the map 430. A selection of such media item may modify the map 430 to comprise a point that represent a GLDR associated with the media item by moving the map 430 along longitudinal and latitudinal axes of the map 430. Such modification may be performed by a map display module, such as 262 of FIG. 2.

The first display section 420 may further display a route 470. The route 470 may be determined based on the collection.

The second display section 440 may comprise a media item such as an image 450. The image 450 may represent a media item associated with a selected GLDR represented by the point 425. The image 450 may be obtained from a media item repository, such as 240 of FIG. 2. The second display section 440 may further comprise a label 460. The label 460 is the label of the image 450 labeled by a media item labeler, such as 252 of FIG. 2.

In some exemplary embodiments, the second display section 440 may further comprise images 449 and 451. The images 449 and 451 may be associated with a same collection such as the image 450 is associated with. The image 449 may be associated with a point that is prior to the point 425 on the route 470, such as 424. The image 451 may be associated with a point that follows the point 425 on the route 470, such as 426.

In other exemplary embodiments, the image 450 may represent a media item associated with a GLDR which is geographically closest to a current location of the media item manager. The media item manager may detect that the current location of the device is geographically close to the GLDR associated with a media item and display the media item. The images 449 and 451 may represent media items associated with GLDRs that are second and third closest to the current location of the media item manager. The display configuration 400 may display some media items differently than other media items. For example, display media items in a bigger size or otherwise marked when such media item is associated with a GLDR closer to the current location of the device. Similarly, when a route is involved, media items the user already passed may be displayed lower in the display device or be displayed in a smaller number of pixels.

What is claimed is:

1. A computerized system comprising:
an input module configured to obtain a media item and a Geographic Location Data Record (GLDR), the media item is associated with the GLDR;
a media item repository configured to store the media item;
a meta-data determinator configured to determine a meta-data associated with the media item, said meta-data is based on the GLDR; and
a display module for displaying the media item stored in said media item repository, the media item is displayed in accordance with the GLDR and the meta-data determined by said meta-data determinator.

2. The computerized system according to claim 1, wherein the media item is selected from the group consisting of an image item, a video item and an audio item.

3. The computerized system according to claim 1, wherein said meta-data determinator comprises a media item labeler configured to label the media item based on the GLDR.

4. The computerized system according to claim 3, wherein said input module is further configured to obtain a temporal indication associated with the media item, said media item labeler is configured to label the media item based on the GLDR and the temporal indication.

5. The computerized system according to claim 1, wherein said meta-data determinator comprises a collection associator configured to associate a collection of two or more media items with the media item based on the GLDR associated with the media item.

6. The computerized system according to claim 5, wherein said input module is further configured to obtain a temporal indication associated with the media item, said collection associator is configured to associate the collection with the media item based on the GLDR and the temporal indication.

7. The computerized system according to claim 5, wherein said meta-data determinator further comprises a collection labeler configured to label the collection based on GLDRs associated with the two or more media items of the collection.

8. The computerized system according to claim 7, wherein said input module is further configured to obtain a temporal indication associated with the media item, said collection labeler is configured to label the collection based on the GLDRs and temporal indications associated with the two or more media items of the collection.

9. The computerized system according to claim 5, wherein said meta-data determinator further comprises a route determinator configured to determine a route based on GLDRs associated with the two or more media items of the collection.

10. The computerized system according to claim 9, wherein said input module is further configured to obtain a temporal indication associated with the media item, said route determinator is configured to determine a route based on the GLDRs and temporal indications associated with the two or more media items of the collection.

11. The computerized system according to claim 1, further comprises a map display module configured to display a map in accordance with the meta-data of the media item.

12. The computerized system according to claim 5, wherein the display module further comprises a collection display module configured to display at least a portion of the two or more media items of the collection.

13. The computerized system according to claim 11, wherein said map display module is configured to modify the map based on a selection of a media item from an at least a portion of two or more media items.

14. The computerized system according to claim 1, wherein the input module is further configured to obtain a current location of said computerized system.

15. The computerized system according to claim 14, wherein the display module is further configured to display the media item in accordance with the current location of said computerized system.

16. A method in a computerized environment, said method comprising:
obtaining a media item and a GLDR, the media item is associated with the GLDR;
storing the media item;
determining a meta-data associated with the media item based on the GLDR; and
displaying the media item stored, the media item is displayed in accordance with the GLDR and the meta-data.

17. The method according to claim 16, wherein labeling the media item based on the GLDR.

18. The method according to claim 17, wherein obtaining a temporal indication associated with the media item; and
labeling the media item based on the GLDR and the temporal indication.

19. The method according to claim 16, wherein associating a collection of two or more media items with the media item based on the GLDR.

20. The method according to claim 19, wherein obtaining a temporal indication associated with the media item; and
associating the collection with the media item based on the GLDR and the temporal indication.

21. The method according to claim 19, wherein labeling the collection based on GLDRs associated with the two or more media items of the collection.

22. The method according to claim 21, wherein obtaining a temporal indication associated with the media item; and
labeling the collection based on the GLDRs and temporal indications associated with the more than one media item associated with the collection.

23. The method according to claim 19, wherein determining a route based on GLDRs associated with the two or more media items of the collection.

24. The method according to claim 23, wherein obtaining a temporal indication associated with the media item; and
determining a route based on the GLDRs and temporal indications associated with the two or more media items of the collection.
